(19) United States
(12) Patent Application Publication
(10) Pub. No.: US 2009/0225880 A1
(43) Pub. Date: Sep. 10, 2009

(54) CONTROL SYSTEM AND METHOD HAVING AN ADAPTABLE ORTHOGONAL MULTIPLEXING MODULATION MECHANISM

(75) Inventors: Wei-Lun Lin, Taipei (TW); Char-Dir Chung, Taipei (TW)

Correspondence Address: EDWARDS ANGELL PALMER & DODGE LLP, P.O. BOX 55874, BOSTON, MA, 02205, US

(73) Assignee: NATIONAL TAIWAN UNIVERSITY, Taipei (TW)

(21) Appl. No.: 12/356,273

(22) Filed: Jan. 20, 2009

(30) Foreign Application Priority Data
Mar. 7, 2008 (TW) 097108002

(51) Int. Cl. H04L 27/28

(52) U.S. Cl. 375/260

(57) ABSTRACT

A control system and a method having an adaptive orthogonal multiplexing modulation mechanism are provided. The control system includes a modulation control module for detecting input signals input to an input signal end and a plurality of modulation types of the orthogonal multiplexing modulation mechanism, selecting suitable modulation types among the modulation types, selecting modulation modes among the modulation types in accordance with the input signals, and enabling the orthogonal multiplexing modulation mechanism to perform modulation and demodulation in accordance with the selected modulation modes.

### BACKGROUND OF THE INVENTION

1. Field of the Invention

This invention relates to control systems and methods, and more particularly, to a control system and method having an orthogonal multiplexing modulation mechanism.

2. Description of Related Art

In a wireless communication system, an analog signal (or a digital signal) having original information is modulated into a modulated signal, and then the modulated signal is sent from a transmitting end through a channel to a receiving end and demodulated into the analog signal to obtain the original information.

The modulation and demodulation techniques are adopted to convey data information through different levels in the amplitude, phase, and frequency of the signal. Since 1960's, a parallel data transmission and frequency division modulation technique is introduced into the art. An orthogonal frequency division multiplexing (OFDM) is one of the most typical modulation techniques. Different from a convention parallel data transmission system, which divides all the available transmission channels into a couple of sub-channels of different non-overlapping frequencies, the OFDM system employs parallel channels to transmit data and designs the sub-carrier signals to be orthogonal to one another at the time domain in accordance with the frequency division modulation that the sub-channels are allowed to overlap, so as to obtain a much high bandwidth efficiency.

In recent years, four distinct modulation families are proposed, i.e. an orthogonally multiplexed orthogonal amplitude modulation (OMOAM), an orthogonally multiplexed orthogonal phase modulation (OMOPM), an orthogonally multiplexed on-off-keyed amplitude modulation (OMO²AM) and an orthogonally multiplexed on-off-keyed phase modulation (OMO²PM).

By selecting different parameters and assigning different base for the above four modulation families, a variety of modulations can be obtained, such as 2NFSK/2PSK, NFSK/4PSK, and NQFPM, which are well-known as power efficient modulations, and 2NOFDM/2PSK, NOFDM/4PSK and NOFDM/K²QAM, which are also well-known as bandwidth efficient modulations. In addition to the conventional modulations, the above four modulation families may constitute many modulations yet being found or discussed. Moreover, the above four modulation families, when designing a multi-dimension modulation system, may also provide an adaptive modulation system more choices in both power and bandwidth efficiencies of the adaptable modulations.

However, these modulations differ in power efficiency and bandwidth efficiency significantly. For example, NQFPM that employs a great number of orthogonal multiplexing orders has a bandwidth efficiency superior to that of the dual orthogonal 2NFSK/2PSK or NFSK/4PSK, but has an average power efficiency. In comparison with 2NOFDM/BPSK and NOFDM/QPSK, NQFPM employs fewer orthogonal multiplexing orders, and therefore has a better power efficiency and a worse bandwidth efficiency. Also, the number of the orthogonal multiplexing orders can not be perceived directly from the power efficiency and the bandwidth efficiency, since the the number of multiplexing level does not strictly related to the power and bandwidth efficiencies.

Therefore, it is desired in the art to develop a system and method that takes bandwidth and power efficiencies of the signals into consideration and selects a most suitable modulation among a variety of modulations, and integrate the selected modulation mode into a dynamically integrated signal architecture, for the optimization of the system throughput.

### SUMMARY OF THE INVENTION

In view of the above-mentioned problems of the prior art, a primary objective is to invent a control system and method providing an adaptive orthogonal multiplexing modulation mechanism, which considers bandwidth efficiency and power efficiency of the modulations and input signals of the dynamic modulation control mechanism, to employ the most suitable modulation to achieve the optimization of the system throughput.

To achieve the above-mentioned and other objectives, a control system and method of an orthogonal multiplexing modulation mechanism are provided according to the present invention, which includes at least one dynamically adjustable type selected from the group consisting of orthogonally multiplexed orthogonal amplitude modulation (OMOAM), orthogonally multiplexed orthogonal phase modulation (OMOPM), orthogonally multiplexed on-off-keyed amplitude modulation (OMO²AM) and orthogonally multiplexed on-off-keyed phase modulation (OMO²PM) modulation families, to practice the modulation selection of the orthogonal multiplexing modulation mechanism.

The control system of the orthogonal multiplexing modulation mechanism in accordance with the present invention includes the orthogonal multiplexing modulation mechanism and a modulation control module. The orthogonal multiplexing modulation mechanism includes an input signal end, a modulation module and a demodulation module. The modulation module and the demodulation module comprise a plurality of modulation type, respectively. The modulation control module is connected to the input signal end. The modulation control module is connected to the modulation module and the demodulation module to detect the modulation types. At least one modulation types mode is pre-selected among the modulation types. Then, the modulation control module selects a modulation mode in accordance with the estimated channel status after selecting the modulation types, and also enables the modulation module and the demodulation module to adopt the selected modulation mode.

The control method of the orthogonal multiplexing modulation mechanism in accordance with the present invention at least includes the steps of (1) detecting a plurality of modulations and input signals of the orthogonal multiplexing modulation mechanism, and setting a pre-select number for modulation modes; (2) selecting a modulation mode among the selected modulation modes in accordance with the estimated channel status; and (3) having the orthogonal multiplexing modulation mechanism to perform modulation and demodulation in accordance with the selected modulation mode.

In another embodiment of the present invention, step (2) includes (2-1) obtaining all information of the modulation type information for the orthogonal multiplexing modulation mechanism, and analyzing bandwidth efficiency and power efficiency of each of the modulation types in accordance with the information of all modulation type information; (2-2) selecting a modulation type having the best bandwidth efficiency as a modulation mode; (2-3) excluding the modulation type of the modulation mode and modulation types having power efficiency worse than power efficiency of the modulation mode; (2-4) selecting a modulation type among the remaining modulation types having the best bandwidth efficiency as a next modulation mode, and determining whether an enough number of modulation modes is selected; if NO, proceeding to step (2-5); if YES, proceeding to step (2-6); (2-5) excluding the modulation type of the next modulation mode and modulation types having power efficiency worse than power efficiency of the next modulation mode, and returning to step (2-4); and (2-6) stopping the selection of modulation modes.

In comparison with the prior art, the control system and control method of the orthogonal multiplexing modulation mechanism according to the present invention employ the modulation control module to detect the input signals input to the input signal end, detect the modulation types of the orthogonal multiplexing modulation mechanism, select an enough number of modulation modes among the modulation types, select a modulation mode among the modulation modes in accordance with the input signals, and enable the orthogonal multiplexing modulation mechanism to perform modulation and demodulation in accordance with the selected modulation mode. In other words, the control system and method of the orthogonal multiplexing modulation mechanism according to the present invention enable the modulation control module 31 to consider bandwidth efficiency and power efficiency in accordance with the relation of modulation models and input signals of the modulation control mechanism, to perform a dynamic modulation control on the orthogonal multiplexing modulation mechanism and employ the most suitable modulation mode to achieve the optimization of bandwidth efficiency and power efficiency of a modulation system.

### BRIEF DESCRIPTION OF DRAWINGS

The invention can be more fully understood by reading the following detailed description of the preferred embodiments, with reference made to the accompanying drawings, wherein:

FIG. 1 is a schematic coordinate diagram illustrating bandwidth efficiency and power efficiency of modulation modes included in OMOAM and OMO²AM modulation families;

FIG. 2 is a schematic diagram of a conventional orthogonal multiplexing modulation mechanism;

FIG. 3 is a schematic diagram of a control system of an orthogonal multiplexing modulation mechanism according to the present invention;

FIG. 4 is a flow chart of a control method for an orthogonal multiplexing modulation mechanism according to the present invention; and

FIG. 5 is a detailed flow chart of step S2 of the control method for the orthogonal multiplexing modulation mechanism according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

Four orthogonal multiplexing modulation families, including OMOAM, OMOPM, OMO²AM, and OMO²PM, are employed in the preferred embodiment of the present invention.

These four modulation families have one common characteristic that the conventional or even unknown modulation types can be modulated from these modulation families by selecting different parameters or different bases for these modulation families. For simplicity, the varieties of the parameter selection and base assignment for these modulation families are represented by parameters N, M, L and K, respectively, wherein N represents the space dimension of base signals in the modulation types, M represents the number of subsets formed from the division of the base signals in the modulation types and the number of supersymbol stream to which the M subsets correspond, L represents the number of orthogonal groups of the modulation types in one base subset, and K represents the amplitude and phase order number of the modulation types. After selection of these four parameters, i.e. N, M, L and K, the various conventional or even unknown modulation types can be defined.

Please refer to Table 1, which is a mapping table of bandwidth efficiency and power efficiency to which each modulation type (M, L, K) of these four modulation families corresponds. Table 1 lists the variation in the bandwidth efficiency and power efficiency due to the change of parameter selection and base assignment of each modulation family. As described previously, different modulation types have different bandwidth efficiency and power efficiency, so if in a dynamically integrated signal architecture the modulation signal selection for the optimal spectral and power efficiency of an orthogonal modulation system is selected, it is necessary to take into consideration the spectral and power efficiency of the orthogonal modulation system at the same time. In the examples listed in Table 1, N is defined to be 8, the maximum of K's of OMOAM and OMO²AM is 16, and the maximum of K's of OMOPM and OMO²PM is 256.

TABLE 1

| | OMOAM | | | OMOPM | | | OMO²AM | | | OMO²PM | | |
|---|---|---|---|---|---|---|---|---|---|---|---|---|
| q | λ_{q,}(M, L K) | Γ_{λq} | Φ_{λq} | λ_{q,}(M, L K) | Γ_{λr} | Φ_{λq} | λ_{q,}(M, L K) | Γ_{λv} | Φ_{λr} | λ_{q,}(M, L K) | Γ_{λr} | Φ_{λv} |
| 0 | (1, 1, 2) | 13.71 | 0.23 | (1, 2, 2) | 13.44 | 0.19 | (1, 4, 2)* | 18.67 | 0.65 | (1, 4, 2) | 17.24 | 0.46 |
| 1 | (1, 4, 2) | 15.42 | 0.28 | (1, 1, 4) | 13.71 | 0.23 | (1, 8, 2) | 19.60 | 0.79 | (1, 2, 4)* | 18.94 | 0.65 |
| 2 | (2, 1, 2) | 16.45 | 0.37 | (1, 2, 4) | 15.42 | 0.28 | (2, 4, 2) | 19.72 | 0.92 | (1, 4, 4) | 19.60 | 0.79 |
| 3 | (2, 4, 2) | 18.52 | 0.46 | (2, 1, 4) | 16.45 | 0.37 | (2, 2, 2)* | 21.70 | 0.97 | (2, 2, 4) | 19.85 | 0.92 |
| 4 | (4, 1, 2) | 19.14 | 0.56 | (2, 2, 4) | 18.52 | 0.46 | (4, 2, 2) | 22.41 | 1.18 | (2, 1, 4)* | 21.70 | 0.97 |
| 5 | (4, 4, 2) | 21.63 | 0.74 | (4, 1, 4) | 19.14 | 0.56 | (2, 1, 2)* | 24.60 | 1.48 | (4, 1, 4) | 22.41 | 1.18 |
| 6 | (2, 4, 4) | 25.42 | 0.83 | (8, 1, 4) | 21.63 | 0.74 | (4, 1, 2)* | 24.80 | 1.62 | (4, 1, 8) | 24.60 | 1.51 |
| 7 | (4, 2, 4) | 25.61 | 0.93 | (8, 1, 8) | 26.78 | 1.11 | (8, 1, 2) | 25.59 | 1.71 | (4, 1, 16) | 30.36 | 1.84 |
| 8 | (8, 1, 4) | 28.29 | 1.11 | (8, 1, 16) | 32.49 | 1.48 | (4, 2, 4) | 28.38 | 1.84 | (4, 1, 32) | 36.24 | 2.17 |
| 9 | (16, 1, 4) | 28.49 | 1.48 | (8, 1, 32) | 38.36 | 1.85 | (4, 1, 4)* | 31.35 | 1.95 | (4, 1, 64) | 42.18 | 2.51 |
| 10 | (16, 1, 8) | 34.60 | 2.22 | (8, 1, 64) | 44.28 | 2.22 | (8, 1, 4) | 32.05 | 2.37 | (4, 1, 128) | 48.13 | 2.83 |
| 11 | (16, 1, 16) | 40.57 | 2.96 | (8, 1, 128) | 50.22 | 2.59 | (4, 2, 8) | 33.51 | 2.51 | (4, 1, 256) | 54.09 | 3.16 |
| 12 | — | — | — | (8, 1, 256) | 56.17 | 2.96 | (8, 1, 8) | 37.74 | 3.03 | — | — | — |
| 13 | — | — | — | — | — | — | (4, 2, 16) | 38.81 | 3.16 | — | — | — |
| 14 | — | — | — | — | — | — | (8, 1, 16) | 43.23 | 3.69 | — | — | — |

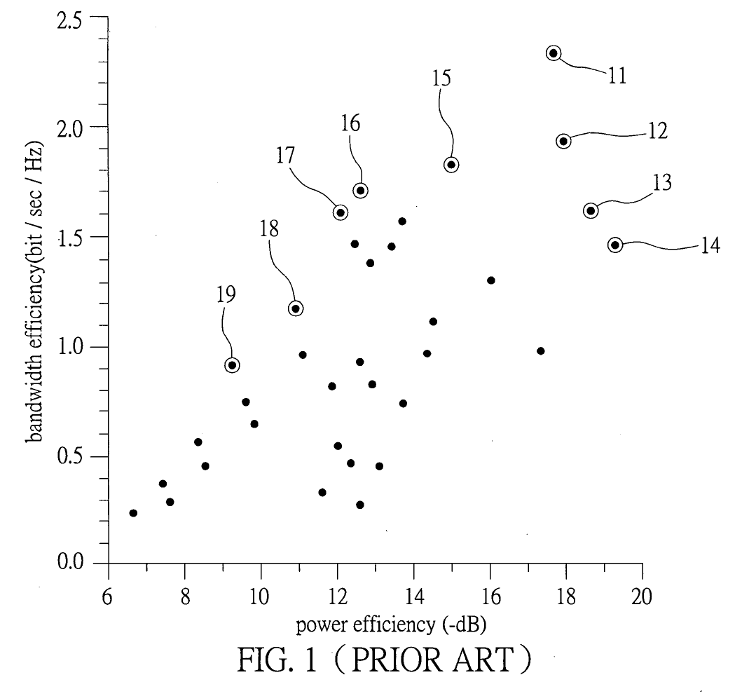

Please refer to FIG. 1, which is a schematic coordinate diagram illustrating bandwidth efficiency and power efficiency of modulation types included in OMOAM and OMO²AM modulation families, with points indicating the modulation types included in OMOAM and OMO²AM modulation families, an ordinate representing the bandwidth efficiency, a larger value in the ordinate corresponding to a greater bandwidth efficiency, and an abscissa representing the power efficiency, a larger value in the abscissa corresponding to a less power efficiency.

As shown in FIG. 1, the highest point in the ordinate indicates one of the modulation types in OMOAM and OMO²AM modulation families having the best bandwidth efficiency. In other words, a modulation type to which the point corresponds is one of all the modulation types included in OMOAM and OMO²AM achieving the best bandwidth efficiency. Here, the highest point in the ordinate is defined as a first point 11, which corresponds to a modulation type included in OMO²AM modulation family having (N, M, L, K) equal to (8, 8, 1, 4).

Moreover, since each point in the abscissa having an abscissa value larger than that of the first point 11, such as a second point 12 that corresponds to a modulation type included in OMO²AM modulation family having (N, M, L, K) equal to (8, 4, 1, 4), a third point 13 that corresponds to a modulation type included in OMO²AM modulation family having (N, M, L, K) equal to (8, 2, 1, 4), and a fourth point 14 that corresponds to a modulation type included in OMO²AM modulation family having (N, M, L, K) equal to (8, 1, 1, 4), has bandwidth efficiency inferior to that of the first point 11 and power efficiency superior to that of the first point 11, that is the modulation types that these points correspond to consuming more transmission energy and unable to achieve better bandwidth efficiency, the control system excludes the use of the modulation types to which the second point 12, the third point 13 and the fourth point 14 correspond.

Then, exclude the use of the selected first point 11 and the second point 12, the third point 13 and the fourth point 14 that have been excluded by the control system. Select among the remaining points a point having the largest ordinate value and define the point as a fifth point 15 that corresponds to a modulation type included in OMO²AM modulation family having (N, M, L, K) equal to (8, 4, 2, 4). Since the ordinate value of the fifth point 15 is a maximum ordinate value after exclusion of the first point 11, the second point 12, the third point 13 and the fourth point 14, that is the power efficiency being confined to be superior to that of a modulation type included in OMO²AM modulation family having (N, M, L, K) equal to (8, 8, 1, 4), to which the first point 11 corresponds, a modulation type among the remaining modulation types having the best bandwidth efficiency is selected to be the next modulation type. In other words, under the consideration that the power consumption cannot exceed the first point 11, it is the modulation type, to which the fifth point 15 corresponds, should be selected as the next modulation type.

Note that the selection of suitable modulation types is not limited to the mapping table of bandwidth efficiency and power efficiency formed based on each modulation type, or the schematic coordinate diagram of bandwidth efficiency and power efficiency, any mechanism can be used in the present invention as long as it can be used for determining bandwidth efficiency and power efficiency to which each modulation type correspond. Moreover, the number of modulation modes is not limited to two. In other words, one or more than two suitable modulation types can be selected, by applying the above-mentioned selection method for suitable modulation types. For example, in addition to the first point 11 and the fifth point 15, more points, such as a sixth point 16, a seventh point 17, an eighth point 18 and a ninth point 19, as shown in FIG. 1, can be selected and their corresponding modulation types are all suitable modulation types and can be used as modulation modes.

Besides, the sample matrix group and available modulation types selected by such the method, which selects signal modulation type in consideration of bandwidth efficiency and power efficiency, are not limited to OMOAM and OMO²AM modulation families. The method is also applicable to OMOPM and OMO²PM modulation families. Specifically, since the use of the variation of parameter selection and base assignment of OMOAM, OMO²AM, OMOPM and OMO²PM can be simplified and represented by N, M, L and K, the modulation control system and its method of the present invention can operate in combination with the various modulation types included in the above four modulation families if each modulation type included in the four modulation families is further analyzed for its bandwidth efficiency and power efficiency and the above selection method is used to select modulation mode groups having desired bandwidth efficiency and power efficiency.

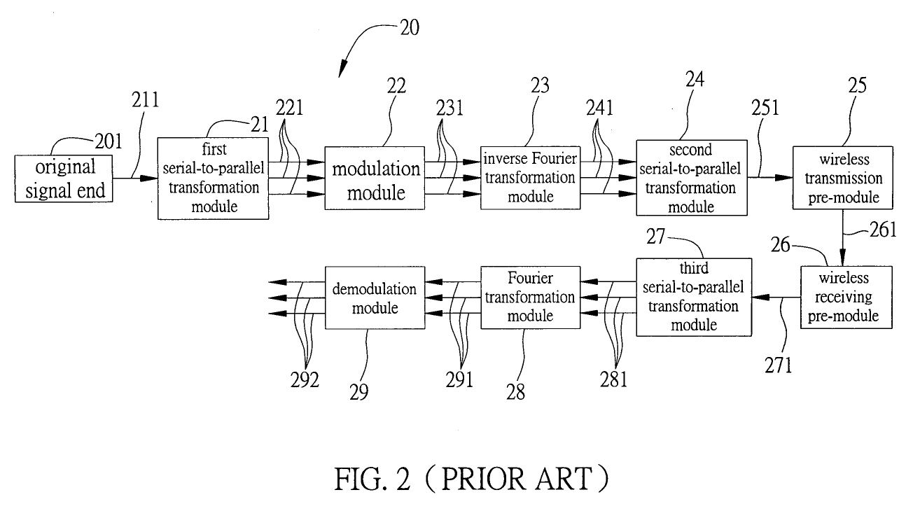

Please refer to FIG. 2, which is a schematic diagram of a conventional orthogonal multiplexing modulation mechanism 20. The conventional orthogonal multiplexing modulation mechanism 20 sends original serial signals 211 at an original signal end 201 to a first serial-to-parallel transformation module 21. The first serial-to-parallel transformation module 21 transforms the original serial signals 211 into original parallel signals 221 and sends the original parallel signals 221 to a modulation module 22. The modulation module 22 receives and modulates the original parallel signals 221 to generate modulation parallel signals 231 and send the modulation parallel signals 231 to an inverse Fourier transformation module 23. The inverse Fourier transformation module 23 receives and performs an inverse Fourier transformation on the modulation parallel signals 231 to generate inverse Fourier transformation signals 241 and send the inverse Fourier transformation signals 241 to a second serial-to-parallel transformation module 24. The second serial-to-parallel transformation module 24 transforms the inverse Fourier transformation signals 241 into serial signals 251, and sends the serial signals 251 to a wireless transmission pre-module 25. The wireless transmission pre-module 25 adds a signal guard sector to, performs a digital-to-analog conversion on, and filters the serial signals 251 to generate transmitting signals 261, which is carried to a high band for transmission.

After receiving the transmitting signals 261 from the wireless transmission pre-module 25, a wireless receiving pre-module 26 carries the transmitting signals 261 to a low band, performs an analog-to-digital transformation on and deprives the transmitting signals 261 of the signal guard sector to generate receiving serial signals 271 and send the receiving serial signals 271 to a third serial-to-parallel transformation module 27. The third serial-to-parallel transformation module 27 receives and transforms the receiving serial signals 271 into receiving parallel signals 281, and sends the receiving parallel signals 281 to a Fourier transformation module 28. The Fourier transformation module 28 receives and transforms the receiving parallel signals 281 into Fourier signals 291, and sends the Fourier signals 291 to a demodulation module 29. The demodulation module 29 demodulates the Fourier signals 291 into parallel output signals 292 and outputs the parallel output signals 292.

Note that the modulation module 22 and the demodulation module 29 of the above conventional orthogonal multiplexing modulation mechanism 20 can employ various modulation techniques, such as 2NFSK/2PSK, NFSK/4PSK, NQFPM, Q2PSK, 2NOFDM/2PSK, NOFDM/4PSK, NOFDM/K2QAM.

However, these modulation modes differs from one another in bandwidth efficiency and power efficiency. For example, NQFPM, which uses a large orthogonal multiplexing order number, is better than 2NFSK/2PSK or NFSK/4PSK in bandwidth efficiency, but has an inferior power efficiency. Compared with 2NOFDM/BPSK and NOFDM/QPSK, NQFPM has smaller orthogonal multiplexing order number, and therefore has better power efficiency and less bandwidth efficiency. Bandwidth efficiency is not necessary to be inversely proportional to power efficiency and does not have any certain relation with power efficiency. It is thus impossible to determine the relation between bandwidth efficiency and power efficiency directly in view of the orthogonal multiplexing order number.

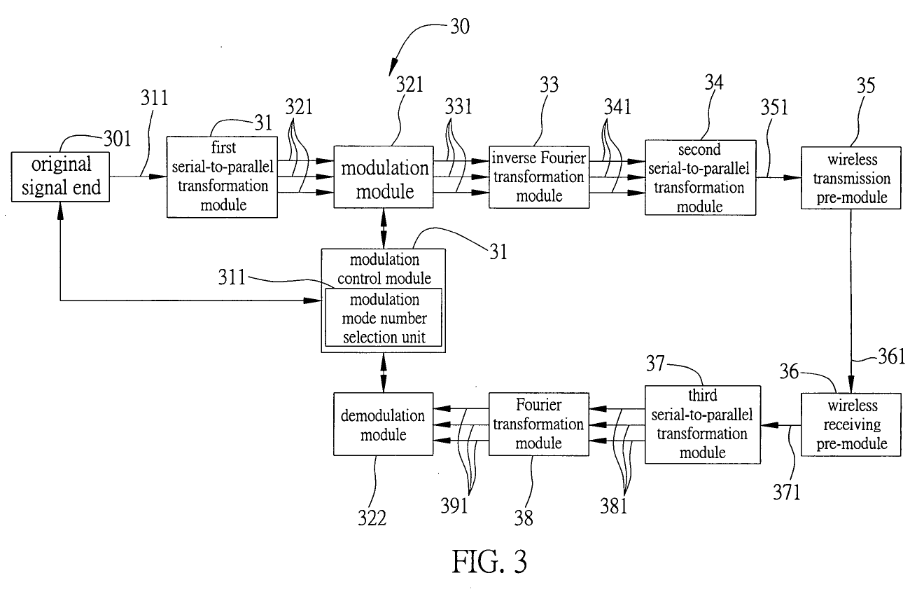

Please refer to FIG. 3, which is a schematic diagram of a control system 30 of an orthogonal multiplexing modulation mechanism according to the present invention. The control system 30 of the orthogonal multiplexing modulation mechanism according to the present invention differs from the conventional orthogonal multiplexing modulation mechanism 20 in that the modulation selection of a modulation module 321 and a demodulation module 322 is increased in the conventional orthogonal multiplexing modulation mechanism 20 such that the modulation modes of the modulation module 321 and the demodulation module 322 comprise at least one of OMOAM, OMOPM, OMO²AM and OMO²PM modulation families and the orthogonal modulation mechanism adjusts modulation and demodulation modes in accordance with selected modulation aspects.

The control system 30 of the orthogonal multiplexing modulation mechanism according to the present invention comprises a modulation control module 31, which comprises a modulation mode number selection unit 311 for inputting modulation mode numbers and is connected to an input signal end 301, the modulation module 321 and the demodulation module 322. The modulation control module 31 receives channel signals from the wireless transmission pre-module 25. The modulation control module 31 determines the number of modulation modes through the modulation mode number selection unit 311, measures and obtains the number, bandwidth efficiency, channel states and power efficiency of modulation modes, analyzes and selects modulation modes in accordance with the number, bandwidth efficiency, channel states and power efficiency of the modulation modes, obtains the input signals input to the input signal end 301, and selects a modulation mode among the selected modulation modes in accordance with the input signals, so as to control the modulation module 321 and the demodulation module 322 to adopt the selected modulation mode, to achieve dynamically modulating the orthogonal multiplexing modulation mechanism and optimize the bandwidth efficiency and power efficiency for signal transmission with the most suitable modulation mode.

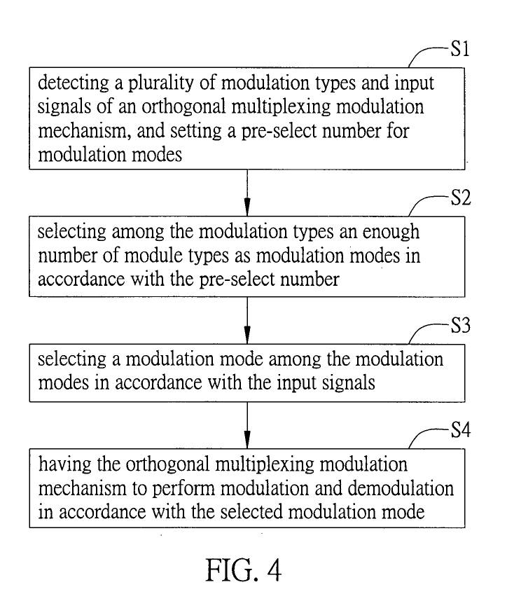

Please refer to FIG. 4, which is a flow chart of a control method of an orthogonal multiplexing modulation mechanism according to the present invention. The control method of the orthogonal multiplexing modulation mechanism comprises at least:

in step S1 detecting a plurality of modulation types and input signals of the orthogonal multiplexing modulation mechanism, and setting a pre-select number for modulation modes, proceeding to step S2;

in step S2 selecting among the modulation types an enough number of module types as modulation modes in accordance with the pre-select number, proceeding to step S3;

in step S3 selecting a modulation mode among the modulation modes in accordance with the input signals, proceeding to step S4; and

in step S4 having the orthogonal multiplexing modulation mechanism to perform modulation and demodulation in accordance with the selected modulation mode.

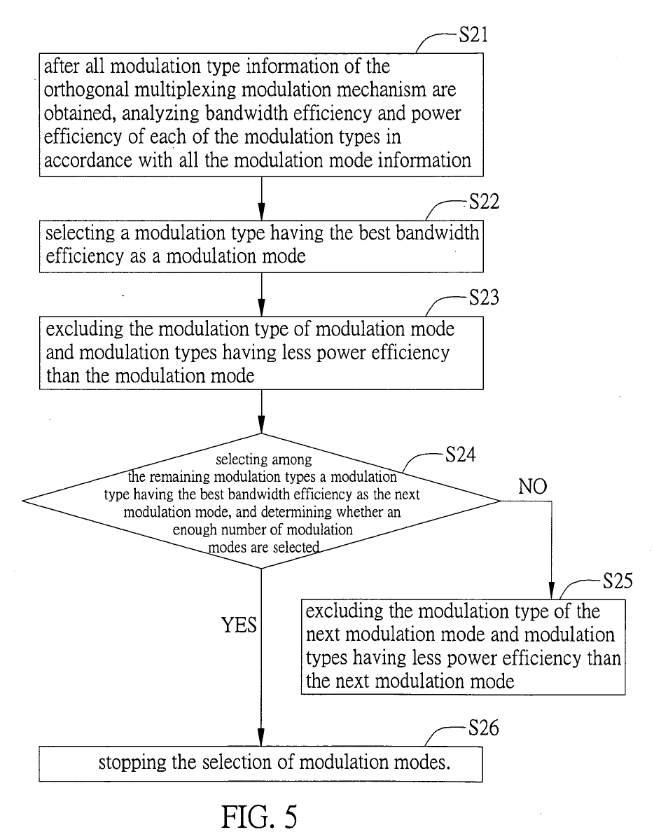

Please refer to FIG. 5, which is a detailed flow chart of step S2 of the control method of the orthogonal multiplexing modulation mechanism according to the present invention. Step S2 further comprises:

in step S21 after all modulation type information of the orthogonal multiplexing modulation mechanism are obtained, analyzing bandwidth efficiency and power efficiency of each of the modulation types in accordance with all the modulation mode information, proceeding to step S22;

in step S22 selecting a modulation type having the best bandwidth efficiency as a modulation mode, proceeding to step S23;

in step S23 excluding the modulation type of modulation mode and modulation types having less power efficiency than the modulation mode, proceeding to step S24;

in step S24 selecting among the remaining modulation types a modulation type having the best bandwidth efficiency as the next modulation mode, and determining whether an enough number of modulation modes are selected; if NO, proceeding to step S25; if YES, proceeding to step S26;

in step S25 excluding the modulation type of the next modulation mode and modulation types having less power efficiency than the next modulation mode, returning to step S24; and

in step S26 stopping the selection of modulation modes.

In conclusion, the control system and control method of the orthogonal multiplexing modulation mechanism according to the present invention employ the modulation control module 31 to detect the input signals input to the input signal end 301, detect the modulation types of the orthogonal multiplexing modulation mechanism, select an enough number of modulation modes among the modulation types, select a modulation mode among the modulation modes in accordance with the input signals, and enable the orthogonal multiplexing modulation mechanism to perform modulation and demodulation in accordance with the selected modulation mode.

In other words, the control system and method of the orthogonal multiplexing modulation mechanism according to the present invention enable the modulation control module 31 to consider bandwidth efficiency and power efficiency in accordance with the relation of modulation models and input signals of the modulation control mechanism, to perform a dynamic modulation control on the orthogonal multiplexing modulation mechanism and employ the most suitable modulation mode to achieve the optimization of bandwidth efficiency and power efficiency of a modulation system.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A control system having an adaptive orthogonal multiplexing modulation mechanism, comprising:
an orthogonal multiplexing modulation mechanism comprising an input signal end, a wireless transmission pre-module, a modulation module and a demodulation module, the modulation module and the demodulation module each having a plurality of modulation types; and
a modulation control module connected to the input signal end, the modulation module and the demodulation module for obtaining characteristics and channel states of input signals input to the input signal end, selecting at least one modulation mode among the modulation types, and enabling the modulation module and the demodulation module to adopt the at least one modulation mode in accordance with the input signals after the at least one modulation mode is selected.

2. The control system of claim 1, wherein the modulation control module selects a plurality of modulation modes among the modulation types, measures channel states after selecting the modulation modes, selects a specific modulation mode among the modulation modes in accordance with the input signals and the channel states, and enables the modulation module and the demodulation module to adopt the specific modulation mode.

3. The control system of claim 1, wherein the modulation types comprise at least one modulation family selected from the group consisting of orthogonally multiplexed orthogonal amplitude modulation (OMOAM), orthogonally multiplexed orthogonal phase modulation (OMOPM), orthogonally multiplexed on-off-keyed amplitude modulation (OMO²AM) and orthogonally multiplexed on-off-keyed phase modulation (OMO²PM) modulation families.

4. The control system of claim 3, wherein the modulation types included in the at least one modulation family are simplified and represented by four parameters, N, M, L and K, to define specific modulation types, wherein N represents space dimension of base signals in the modulation types, M represents number of subsets formed from the division of the base signals in the modulation types and number of supersymbol stream to which the M subsets correspond, L represents number of orthogonal groups of the modulation types in one base subset, and K represents amplitude and phase order number of the modulation types.

5. The control system of claim 1, wherein the modulation control module further comprises a mode number selection unit for setting a pre-select number for modulation modes.

6. The control system of claim 5, wherein the modulation control module selects sufficient modulation modes in accordance with the pre-select number set by the mode number selection unit.

7. The control system of claim 1, wherein the modulation modes at least comprise a modulation mode and a next modulation mode included in the modulation types.

8. The control system of claim 7, wherein the modulation mode has the best bandwidth efficiency in the modulation types, and the next modulation mode has the best bandwidth efficiency in modulation types, excluding the modulation mode and modulation modes having power efficiency worse than that of the modulation mode.

9. The control system of claim 8, wherein the modulation mode further comprises another modulation mode having the best bandwidth efficiency in modulation types, excluding the next modulation mode and modulation types having power efficiency worse than that of the next modulation mode.

10. The control system of claim 1, further comprising:
an original signal end for sending original serial signals; and
a first serial-to-parallel transformation module for receiving the original serial signals, transforming the original serial signals into original parallel signals, and sending the original parallel signals to the modulation module.

11. The control system of claim 10, wherein the original parallel signals are modulated and modulation parallel signals are generated by the modulation module in accordance with the at least one modulation mode.

12. The control system of claim 11, further comprising:
an inverse Fourier transformation module for receiving the modulation parallel signals and performing an inverse Fourier transformation on the modulation parallel signals to generate inverse Fourier transformation signals;
a second serial-to-parallel transformation module for receiving the inverse Fourier transformation signals and transforming the inverse Fourier transformation signals into serial signals; and
a wireless transmission pre-module for receiving the serial signals, adding a signal guard section to the serial signals, performing a digital-to-analog transformation, performing a filtering process, outputting transmitting signals, and carrying the transmitting signals to a high band for transmission.

13. The control system of claim 12, further comprising:
a wireless receiving pre-module for receiving the transmitting signals sent from the wireless transmission pre-module, carrying the transmitting signals to a low band, performing an analog-to-digital transformation, depriving the transmitting signals of the signal guard section, and generating receiving serial signals;
a third serial-to-parallel transformation module for receiving the receiving serial signals and transforming the receiving serial signals into receiving parallel signals; and
a Fourier transformation module for receiving the receiving parallel signals and transforming the receiving parallel signals into Fourier signals.

14. The control system of claim 13, wherein the Fourier signals are demodulated and transformed into parallel output signals by the demodulation module in accordance with the at least one modulation mode.

15. A control method of an adaptive orthogonal multiplexing modulation mechanism, comprising the following steps of:
(1) detecting a plurality of modulation types and input signals of an orthogonal multiplexing modulation mechanism, and setting a pre-select number for modulation modes;
(2) selecting the pre-select number of modulation modes among the modulation types;
(3) selecting a specific modulation mode among the pre-select number of modulation modes in accordance with the input signals; and
(4) having the orthogonal multiplexing modulation mechanism to perform modulation and demodulation in accordance with the specific modulation mode.

16. The control method of claim 15, wherein step (2) further comprises the following steps of:
(2-1) obtaining all modulation type information of the orthogonal multiplexing modulation mechanism, and analyzing bandwidth efficiency and power efficiency of each of the modulation types in accordance the all modulation type information;
(2-2) selecting a modulation type having the best bandwidth efficiency as a modulation mode;
(2-3) excluding the modulation type of the modulation mode and modulation types having power efficiency worse than power efficiency of the modulation mode;
(2-4) selecting a modulation type among remaining modulation types having the best bandwidth efficiency as a next modulation mode, and determining whether a sufficient number of modulation modes are selected; if NO, proceeding to step (2-5); if YES, proceeding to step (2-6);
(2-5) excluding the modulation type of the next modulation mode and modulation types having power efficiency worse than power efficiency of the next modulation mode, and returning to step (2-4); and
(2-6) stopping selecting modulation modes.

17. The control method of claim 15, wherein step (4) is performed for adjusting modulation modes and demodulation modes of the orthogonal multiplexing modulation mechanism in accordance with the specific modulation mode.

18. The control method of claim 15, wherein the modulation types comprise at least one modulation family selected from the group consisting of OMOAM, OMOPM, OMO²AM and OMO²PM modulation families.

19. The control method of claim 18, wherein the modulation types included in each modulation family are simplified and represented by four parameters, N, M, L and K, to define specific modulation types, wherein N represents space dimension of base signals in the modulation types, M represents number of subsets formed from the division of the base signals in the modulation types and number of supersymbol stream to which the M subsets correspond, L represents number of orthogonal groups of the modulation types in one base subset, and K represents amplitude and phase order number of the modulation types.

20. The control method of claim 15, wherein the modulation modes at least comprise a modulation mode and a next modulation mode included in the modulation types.

21. The control method of claim 20, wherein the modulation mode has the best bandwidth efficiency in the modulation types, and the next modulation mode has the best bandwidth efficiency in modulation types, excluding the modulation mode and modulation modes having power efficiency worse than that of the modulation mode.

22. The control method of claim 21, wherein the modulation mode further comprises another modulation mode having the best bandwidth efficiency in modulation types, excluding the next modulation mode and modulation types having power efficiency worse than that of the next modulation mode.
